(19) United States
(12) Patent Application Publication
(10) Pub. No.: US 2011/0175849 A1
(43) Pub. Date: Jul. 21, 2011

(54) OPTICAL TOUCH DISPLAY DEVICE AND METHOD

(75) Inventor: CHUEH-PIN KO, TAIPEI CITY (TW)

(73) Assignee: ACER INCORPORATED, TAIPEI COUNTY (TW)

(21) Appl. No.: 12/770,707

(22) Filed: Apr. 29, 2010

(30) Foreign Application Priority Data
Jan. 18, 2010 (TW) 099101276

(51) Int. Cl. G06F 3/042

(52) U.S. Cl. 345/175

(57) ABSTRACT

An optical touch display device includes a display screen capable of emitting an invisible light, at least one image acquisition module, and a processing module. The image acquisition module is arranged at a peripheral edge of the display screen for acquiring an invisible light image on or above a surface of the display screen. The processing module calculates a spatial position of an object according to a position of the object in the invisible light image acquired by the image acquisition module. With these arrangements, the optical touch display device can have an effectively reduced thickness and the spatial position of the object can be determined in increased accuracy. Further, the processing module can determine a user's gesture according to the acquired invisible light image. A method for implementing optical touch display is also disclosed.

### FIELD OF THE INVENTION

The present invention relates to an optical touch display device and method, and more particularly to an optical touch display device and method that uses a display screen capable of emitting an invisible light to execute determination of touch of the display screen by an object.

### BACKGROUND OF THE INVENTION

Currently, people pay more and more attention to the touch-operation interface. In the past, most of the touch screens were small-size touch screens and were usually resistive or capacitive touch screens. However, there are now various screen sizes available for the touch screens. For large-size touch screens, such as 17″ to 30″ touch screens, they are implemented mainly using an optical touch display technique, in which infrared (IR) light and image acquisition modules externally attached to an outer frame of the display panel are employed. More specifically, with the optical touch display technique, IR sensors and IR light sources are provided on upper left and upper right corners of the touch screen, and reflectors are provided along peripheral edges of the touch screen. IR light beams emitted from the two IR light sources are projected onto the reflectors to thereby form a light screen, and the two IR sensors receive any change on the light screen. When an object touches the screen, the object would block the light screen and there would be a dark area formed on images received by the IR sensors. Therefore, the position on the touch screen being touched by the object can be calculated according to the position of the dark area using trigonometric function.

In the conventional optical touch display technique, the provision of the reflectors on the peripheral edges of the touch screen would inevitably increase the thickness of the screen mechanism and prevent the screen from having an aesthetic appearance.

### SUMMARY OF THE INVENTION

A primary object of the present invention is to provide an optical touch display device and method, so that a display screen of the optical touch display device does not have an increased thickness due to increased optical touch functions thereof.

To achieve the above and other objects, the optical touch display device according to the present invention includes a display screen, at least one image acquisition module, and a processing module. The display screen includes a display panel and a light source. The display panel displays data thereon, and the light source emits a visible light and an invisible light. The at least one image acquisition module is arranged at a peripheral edge of the display screen for acquiring an invisible light image on or above a surface of the display screen. The processing module calculates a spatial position of an object according to a position of the object in the invisible light image acquired by the image acquisition module.

In the present invention, a coordinate detection zone is defined on or above a surface of a display zone of the display screen, and the spatial position of the object is a coordinate of the object in the coordinate detection zone.

In the present invention, the processing module determines a contour of the object according to relatively bright areas in the invisible light image, and then determines the position of the object in the invisible light image according to the contour of the object.

In the present invention, when the invisible light image includes a mirror image of the object in contact with the display screen, the processing module determines the position of the object in the invisible light image according to the mirror image.

In an embodiment of the present invention, there are three image acquisition modules, which are separately arranged at an upper left corner, an upper right corner, and an upper side of the display screen. And, the image acquisition module arranged at the upper side of the display screen is used to acquire an invisible light image in front of the display screen.

In the above embodiment, the object can be a user's hand, and the processing module calculates the spatial position of the hand and recognizes a gesture thereof according to the invisible light images acquired by the image acquisition modules.

To achieve the above and other objects, the optical touch display method according to the present invention includes the following steps: providing a light source in a display screen, and the light source being capable of emitting an invisible light; arranging at least one image acquisition module at a peripheral edge of the display screen; using the at least one image acquisition module to acquire an invisible light image on or above a surface of the display screen; and using a processing module to calculate a spatial position of an object according to a position of the object in the invisible light image acquired by the at least one image acquisition module.

The optical touch display method of the present invention further includes a step of defining a coordinate detection zone on or above a surface of a display zone of the display screen. And, the spatial position of the object is a coordinate of the object in the coordinate detection zone.

According to the optical touch display method of the present invention, the processing module determines a contour of the object according to relatively bright areas in the acquired invisible light image, and then determines the position of the object in the invisible light image according to the contour of the object.

In an embodiment of the method of the present invention, when the invisible light image includes a minor image of the object in contact with the display screen, the processing module determines the position of the object in the invisible light image according to the minor image.

In an embodiment of the method of the present invention, there are three image acquisition modules separately arranged at an upper left comer, an upper right corner, and an upper side of the display screen. And, the image acquisition module arranged at the upper side of the display screen is used to acquire an invisible light image in front of the display screen.

In the above embodiment, the object can be a user's hand, and the processing module calculates the spatial position of the hand and recognizes a gesture thereof according to the invisible light images acquired by the image acquisition modules.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an optical touch display device according to a first embodiment of the present invention;

FIG. 2 is a schematic view of the optical touch display device according to the first embodiment of the present invention;

FIG. 3 shows an example of an object contour in an invisible light image acquired by the optical touch display device of the present invention;

FIG. 4 shows the brightest areas of the object in the invisible light image acquired by the optical touch display device of the present invention;

FIG. 5 shows an example of a mirror image in an invisible light image acquired by the optical touch display device of the present invention;

FIG. 6 schematically shows the minor image in the acquired invisible light image after image binarization;

FIG. 7 is a block diagram of an optical touch display device according to a second embodiment of the present invention;

FIG. 8 is a schematic view of the optical touch display device according to the second embodiment of the present invention;

FIG. 9 is a flowchart showing the steps included in an optical touch display method according to the present invention; and

FIG. 10 is a flowchart showing the steps included in the optical touch display method of the present invention for image content analysis.

### DETAILED DESCRIPTION OF THE PREFERRED EMBODIMENTS

The present invention will now be described with some preferred embodiments thereof. For the purpose of easy to understand, elements that are the same in the preferred embodiments are denoted by the same reference numerals.

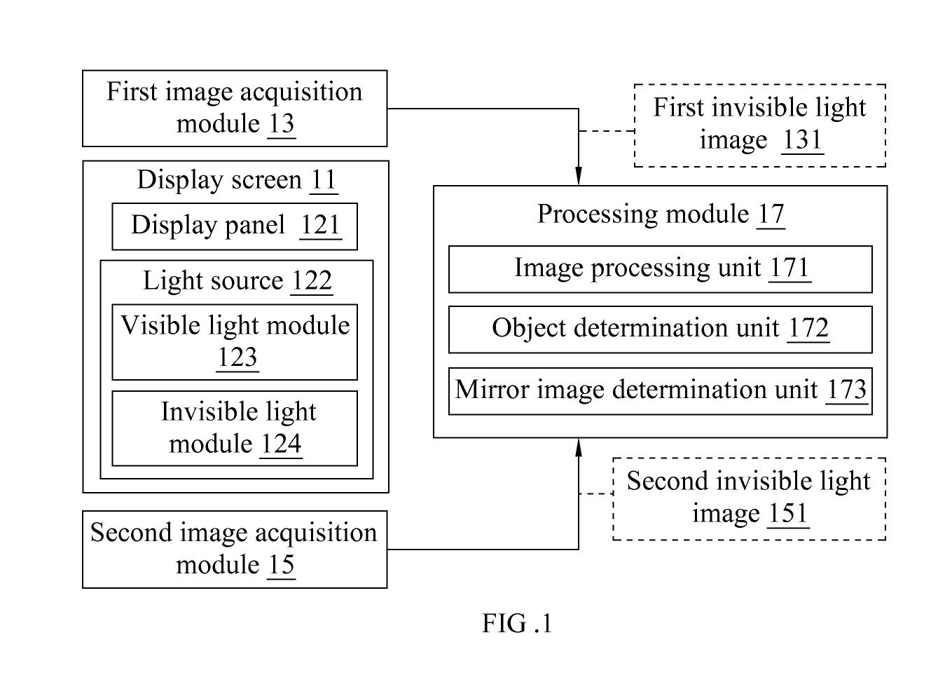

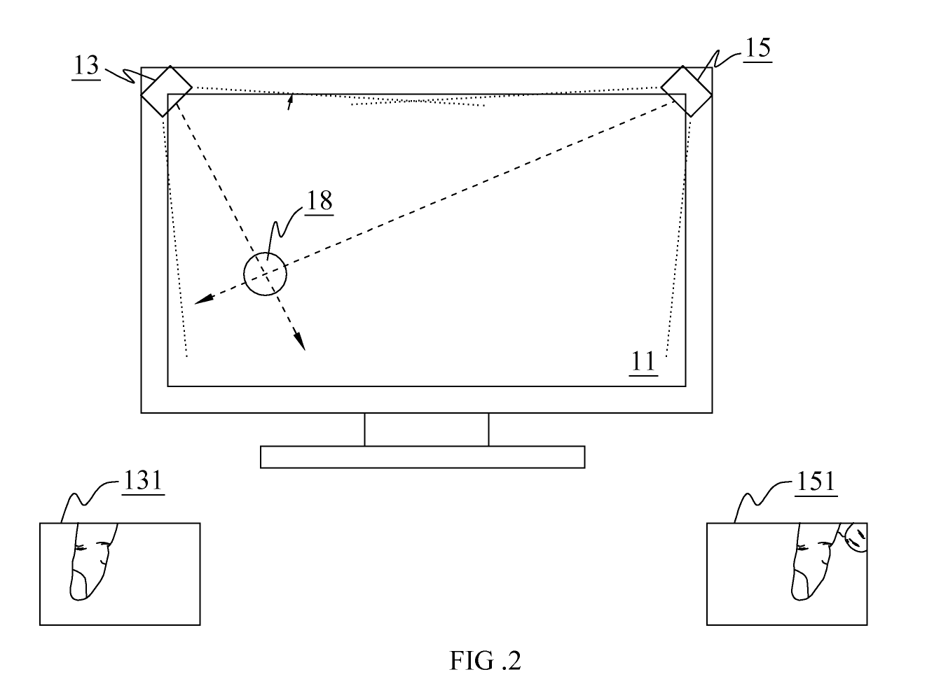

Please refer to FIGS. 1 and 2 that are block diagram and schematic view, respectively, of an optical touch display device according to a first embodiment of the present invention. As shown, the optical touch display device in the first embodiment of the present invention includes a display screen 11, a first image acquisition module 13, a second image acquisition module 15, and a processing module 17. The display screen 11 includes a display panel 121 and a light source 122. The display panel 121 displays data thereon. The light source 122 includes a visible light module 123 and an invisible light module 124. Preferably, the invisible light module 124 is an IR light emitting module. The invisible light module 124 can emit light constantly; or emit light intermittently in coordination with the first and second image acquisition modules 13, 15, such as emitting light only when the first and second image acquisition modules 13, 15 are acquiring an image; or work based on display characteristics of the display screen 11 to emit light only at a particular frame or a specific frequency. The display screen 11 preferably includes a non-self-luminous display panel, such as a liquid crystal panel or an electrochromic panel, and a backlight module having infrared light-emitting diodes (IR LEDs); or includes a self-luminous panel with IR LED pixels, such as an organic light-emitting diode (OLED) panel, a polymeric light-emitting diode (PLED) panel, or a plasma panel; or includes a specially designed display panel having IR transmitted-light independent sub-pixels; or includes a specially designed display panel having IR transmitted-light primary color sub-pixels.

When viewing in front of the display screen 11, the first image acquisition module 13 is arranged at an upper left corner of the display screen 11 and the second image acquisition module 15 is arranged at an upper right corner of the display screen 11, as shown in FIG. 2. The first image acquisition module 13 and the second image acquisition module 15 respectively have an angle of view wide enough for covering a large part of the display screen 11. Herein, a coordinate detection zone is defined on or above a surface of a display zone of the display screen 11.

The first image acquisition module 13 and the second image acquisition module 15 are used to acquire a first invisible light image 131 and a second invisible light image 151, respectively, on or above the surface of the display screen 11. The processing module 17 includes an image processing unit 171 for processing the first and second invisible light images 131, 151; and an object determination unit 172 for determining based on contents of the processed images whether there is a specific object in the invisible light images 131, 151, such as a user's finger, a touch pen, or an article having a pointed tip. Since the invisible light emitted from the display screen 11 does not directly project onto the image acquisition modules, the first invisible light image 131 and the second invisible light image 151 respectively acquired by the first and the second image acquisition module 13, 15 are relatively dark images when there is not any object approaching the display screen 11. Even after an image processing, such as the image binarization process, these dark images would not show any specific image. When an object 18 approaches the display screen 11, the invisible light emitted from the display screen 11 is reflected by the object 18 onto the first image acquisition module 13 and the second image acquisition module 15. Therefore, a relatively bright area in each of the images acquired by the first and the second image acquisition module 13, 15 are determined as the image of the object 18, such as a finger image shown in the invisible light images 131, 151. After image binarization, the areas in the invisible light images 131, 151 corresponding to the finger image would turn into white images, which can be used as a basis in further determination process.

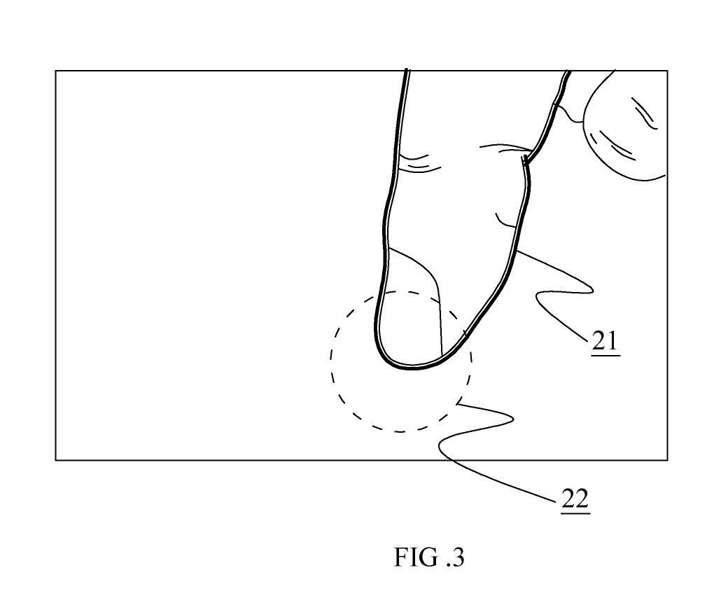

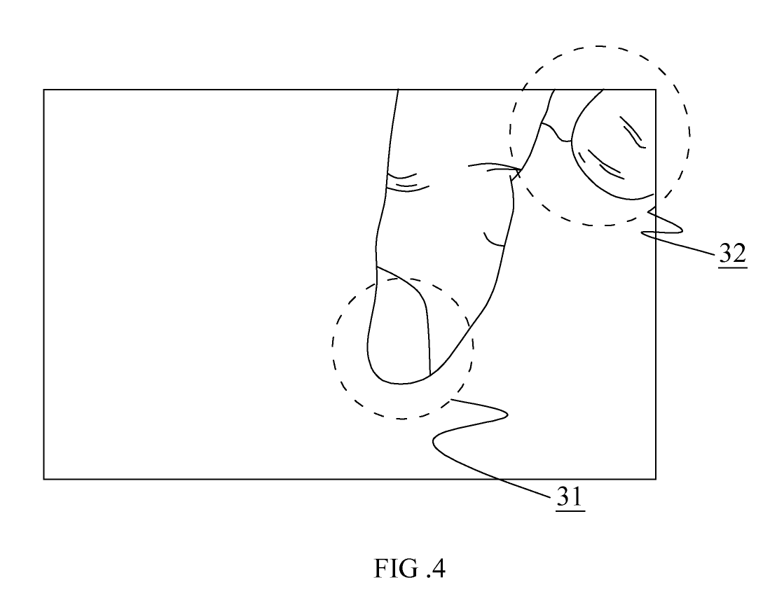

Thus, the processing module 17 can first analyze the relatively bright areas in the invisible light images 131, 151, and then analyzes a contour 21 of each of the relatively bright areas, as shown in FIG. 3. Further, one or more specific points of interest on the contour 21, such as a tip portion 22 on the contour 21, and/or a lowest, a leftmost, an highest, or a rightmost portion on the contour 21 are obtained for determining a position of the object 18. Alternatively, since an object closer to the display screen 11 would reflect more intensive invisible light, the processing module 17 can also analyze the brightest areas in each of the invisible light images 131, 151. Please refer to FIG. 4. When a user's hand approaches the display screen 11, more invisible light would be reflected by portions of the user's hand that directly face the display screen 11. Therefore, images of the user's index finger tip 31 and other clenched fingers 32 are brightest in the invisible light images 131, 151, and the processing module 17 can first analyze the brightest areas in the invisible light images 131, 151 and use the positions of these brightest areas as the position of the object 18. In the case there are multiple areas in the invisible light images 131, 151 satisfying the definition of brightest area, the above-mentioned contour analysis can be executed to select one of the brightest areas for use as the position of the object 18.

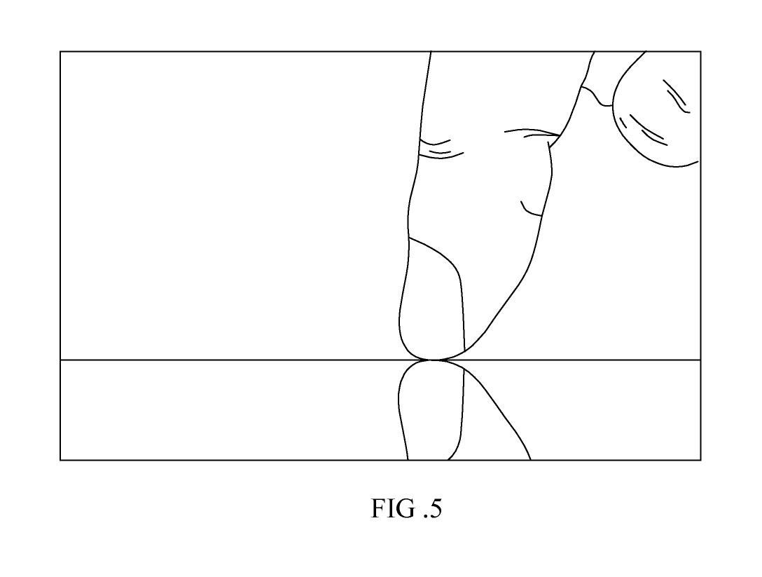

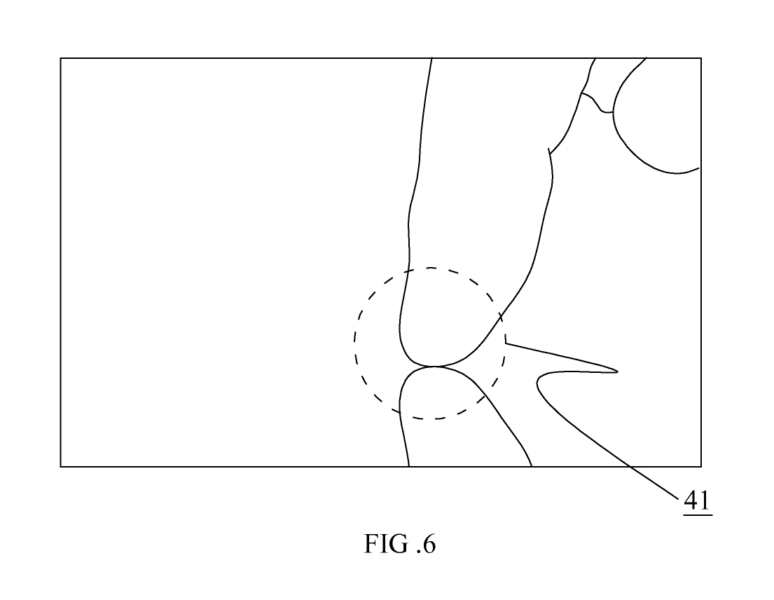

For the optical touch display device to be able to determine whether an object touches, that is, is in contact with the display screen 11, the first image acquisition module 13 and the second image acquisition module 15 are adjusted for their angles of view to cover the surface of the display screen 11, and the processing module 17 can include a mirror image determination unit 173. Since the display screen 11 emits invisible light, an object touching the surface of the display screen 11 would bring two mirror images to show in each of the images acquired by the first image acquisition module 13 and the second image acquisition module 15, as shown in FIG. 5. Two mirror images are apparently symmetric in shape that can be easily recognized, compared to the invisible light images 131, 151. Therefore, the processing module 17 can analyze whether there are mirror images shown hi each of the invisible light images to determine whether the display screen 11 is touched by an object or not. For example, the images acquired by the first image acquisition module 13 and the second image acquisition module 15 can be analyzed using binarization technique to obtain black-and-white images as shown in FIG. 6. In the case the white portions in the black-and-white images also distribute on a lower part of the images, it indicates there are mirror images and the display screen 11 is touched by an object. The processing module 17 can analyze a junction of the object's image and the mirror image thereof, and determines the junction as a position on the display screen 11 being touched by the object, such as the image area 41 in FIG. 6, at where two symmetric shapes join. The processing module 17 can obtain the position of this area. In executing the above-described determination mechanisms, the processing module 17 can process only a particular area of the images. For example, when the acquired image has a resolution of 640×480, the processing module 17 can process only a middle area of the image, such as a 640×20 area located between the 300^{th} and the 320^{th} horizontal pixel line, or a 600×10 rectangular block centered at the acquired image.

When the processing module 17 determines there is an object in the invisible light image and analyzes to obtain the position of the object in the invisible light image, the processing module 17 can further calculate a spatial position of the object 18 according to the positions of the first image acquisition module 13 and the second image acquisition module 15 on the display screen 11 and using the triangulation algorithm. The obtained spatial position is also the coordinate of the object 18 in the coordinate detection zone defined on the display zone of the display screen 11. The coordinate can be a two-dimensional coordinate or a three-dimensional coordinate.

It is noted the present invention provides different determination mechanisms as mentioned above, including determining the object position according to the brightest areas in the acquired invisible light images, determining the object position according to the detected object contour, and determining whether the object touches the display screen according to any existence of a mirror image in the acquired invisible light images. The processing module 17 can execute only one of these determination mechanisms or execute different combinations thereof according on actual need without being limited to the above description. More specifically, whether the processing module 17 should execute only one of these determination mechanisms or execute different combinations thereof can be decided by the designer of the optical touch display device according to the intended usage of the device.

When the determination mechanism based on the detected object contour is executed, the processing module 17 can further distinguish the object as a user's hand, a pen, or other highly IR-reflective or IR-absorbing object, and applies the obtained result in back-end process.

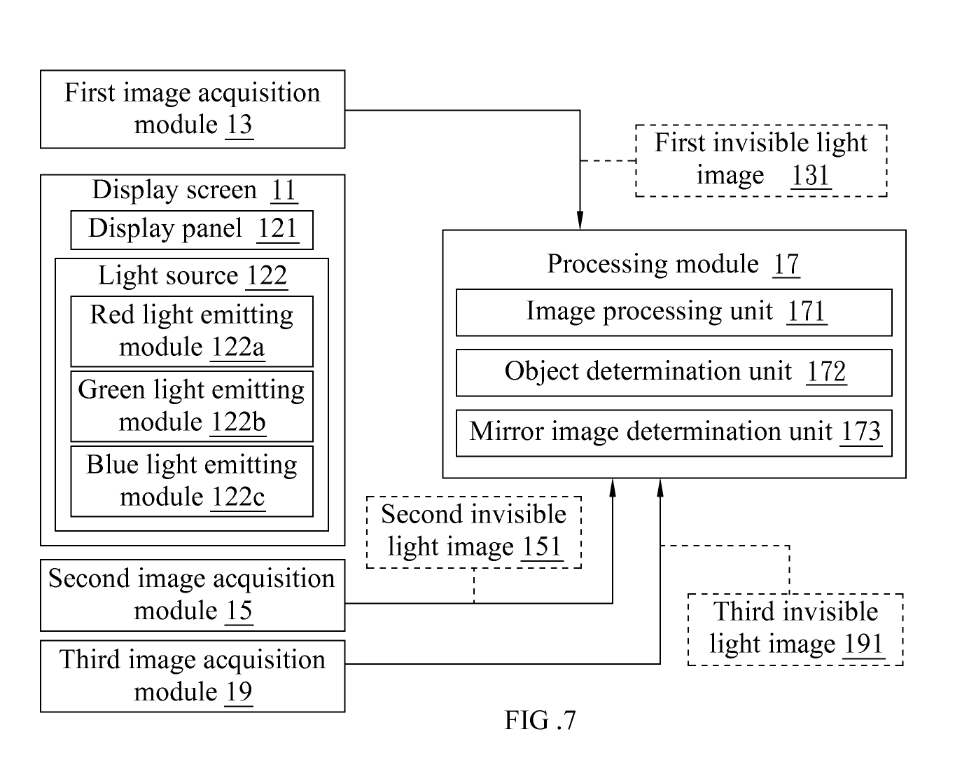

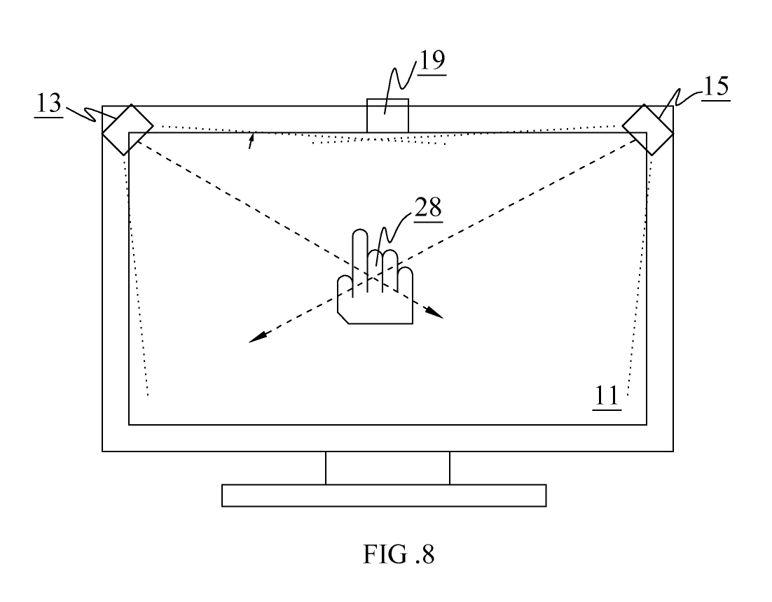

Please refer to FIGS. 7 and 8 that are block diagram and schematic view, respectively, of an optical touch display device according to a second embodiment of the present invention. The second embodiment is different from the first embodiment mainly in that the second embodiment includes an additional third image acquisition module 19. Moreover, the display screen 11 in the second embodiment has a light source 122 including a red light emitting module 122a, a green light emitting module 122b, and a blue light emitting module 122c. The red light emitting module 122a has an emission wavelength ranged between 700 nm and 1400 nm. The red light emitting modules 122a, the green light emitting modules 122b and the blue light emitting modules 122c are preferably implemented as red, blue and green light emitting diodes (LEDs), respectively, with the red light emitting diode having an emission wavelength ranged between 700 nm and 1400 nm. Alternatively, the red light emitting modules 122a, the green light emitting modules 122b and the blue light emitting modules 122c can be implemented as filters of different filter wavelengths working with a white light source while one of the filters has a filter wavelength ranged between 700 nm and 1400 nm. The third image acquisition module 19 is arranged at an upper side of the display screen 11 to locate between the first image acquisition module 13 and the second image acquisition module 15. The third image acquisition module 19 is able to acquire a third invisible light image 191 of an object 28 and accordingly determines the characteristics of the object, such as a gesture thereof. Alternatively, based on the image of the object 28 acquired by the third image acquisition module 19, the processing module 17 can determine information about two or three degrees of freedom of the object 28. For example, based on changes in the size of the object, the processing module 17 can determine a position of the object relative to the display screen 11 or a distance between the object 28 and the display screen 11.

In the present invention, the first image acquisition module 13 and the second image acquisition module 15 are not necessarily arranged at the upper left and the upper right corner of the display screen 11 as shown in FIGS. 2 and 8, but can be both arranged at the upper side of the display screen 11. Further, the first image acquisition module 13, the second image acquisition module 15, and the third image acquisition module 19 can be exchanged in position depending on actual need. Basically, the first and the second image acquisition module 13, 15 are so arranged that they can separately acquire invisible light images on or above the surface of the display screen 11, and the third image acquisition module 19 is so arranged that it can acquire an image in front of the display screen 11.

In addition, the first image acquisition module 13, the second image acquisition module 15, and the third image acquisition module 19 can be dynamically enabled under control of the processing module 17. For example, when the processing module 17 determines there is a specific object in the images acquired by the first and the second image acquisition module 13, 15, it indicates there is an object very close to the surface of the display screen 11. In this case, the processing module 17 can temporarily disable the third image acquisition module 19 to save power consumption thereof. On the other hand, when it is determined there is not any specific object in the images acquired by the first and the second image acquisition module 13, 15, the processing module 17 can enable the third image acquisition module 19 to acquire an image in front of the display screen 11, and disable the first and second image acquisition modules 13, 15 at the same time, if necessary, to save power consumption thereof.

Further, in the second embodiment of the present invention, while there are the first and the second image acquisition modules 13, 15 separately arranged at upper left and upper right corners of the display screen 11, it is also possible to omit the first and second image acquisition modules 13, 15 from the display screen 11 in actual design, so that only the third image acquisition module 19 is equipped on the optical touch display device of the present invention. In the latter case, the invisible light emitted from the display screen 11 will be projected into a space in front of the display screen 11, and the third image acquisition module 19 can acquire an image. With the image acquired by the third image acquisition module 19, it is able to determine whether there is any object in front of the display screen 11. If it is determined there is an object in front of the display screen 11, then a position of the object relative to the display screen 11 or a distance between the object and the display screen 11 can be further determined.

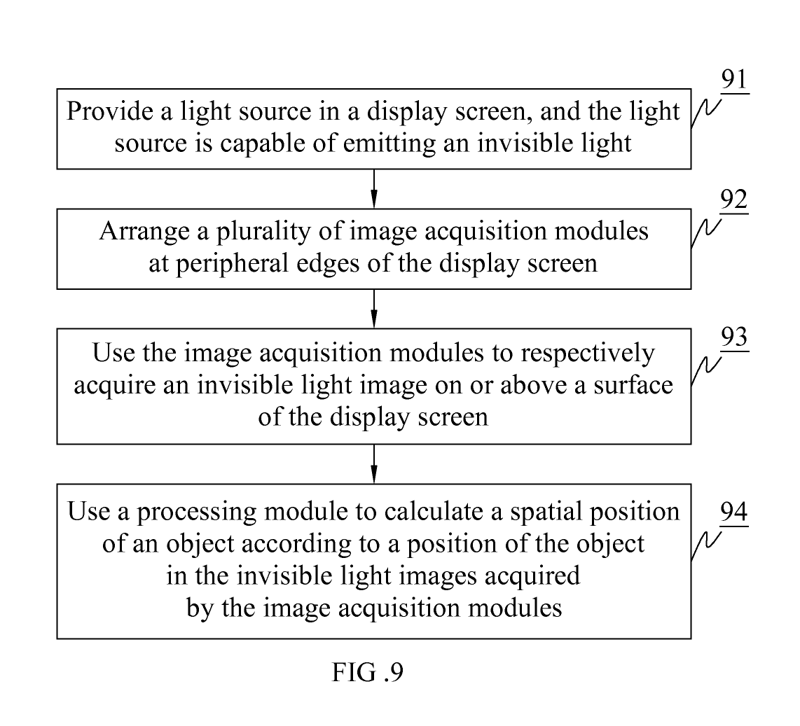

Please refer to FIG. 9 that is a flowchart showing the steps included in an optical touch display method according to the present invention. As shown, in a first step 91, a light source capable of emitting an invisible light is provided in a display screen. In practical implementation, the light source can include a visible light module and an invisible light module. Alternatively, the light source can include a red light emitting module, a blue light emitting module, and a green light emitting module; and the red light emitting module has an emission wavelength ranged between 700 nm and 1400 nm. Further, the display screen can be driven to emit the invisible light in several different ways, including constantly emitting the invisible light; intermittently emitting the invisible light in coordination with the image acquisition modules provided on the display screen, such as emitting the invisible light only when the image acquisition modules are enabled; or emitting the invisible light only at a particular frame or a specific frequency in coordination with the display characteristics of the display screen.

Then, in a second step 92, a plurality of image acquisition modules is arranged on peripheral edges of the display screen. In the case two image acquisition modules are provided, they are separately arranged at an upper left and an upper right corner of the display screen. Or, in the case three image acquisition modules are provided, they are separately arranged at an upper left and an upper right corner and an upper side of the display screen. In a third step 93, the image acquisition modules are respectively used to acquire an invisible light image on or above the surface of the display screen. In the case of having three image acquisition modules provided on the display screen, the image acquisition module arranged at the upper side of the display screen can be used to acquire an image in front of the display screen. And, in a fourth step 94, use a processing module to calculate a spatial position of an object according to a position of the object in each of the invisible light images acquired by the image acquisition modules. In the case of having the third image acquisition module provided on the upper side of the display screen for acquiring the image in front of the display screen, the processing module can not only calculate the spatial position of the object, but also recognize the characteristics of the object based on the invisible light images acquired by the three image acquisition modules. For example, when the object is a user's hand, the processing module is able to recognize the user's gesture.

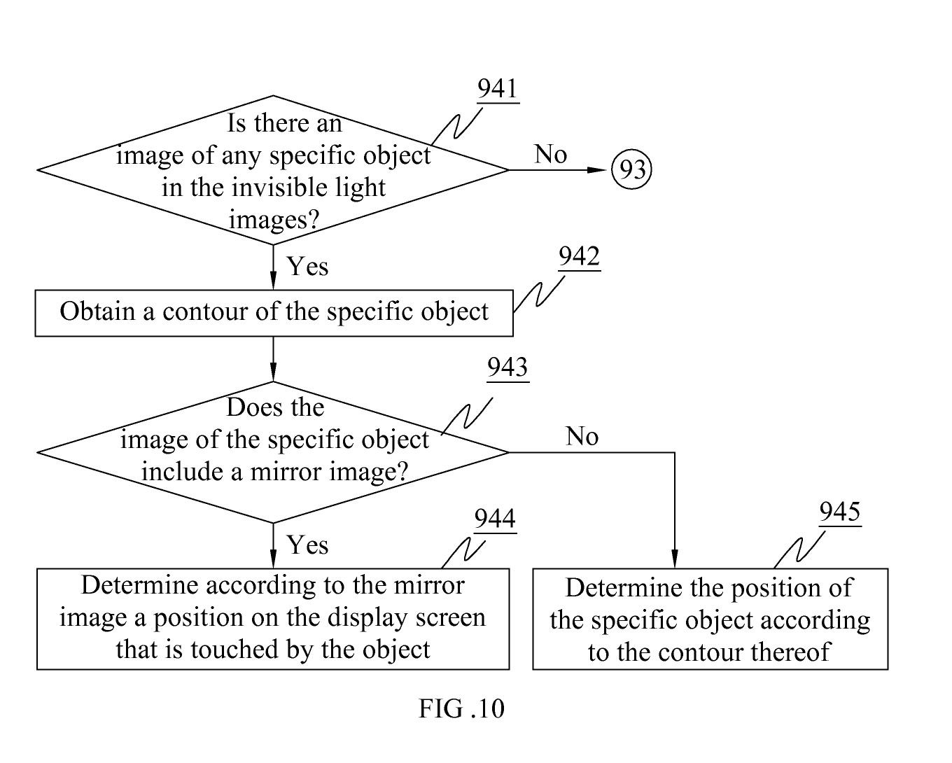

Please refer to FIG. 10 that is a flowchart showing the steps included in the optical touch display method of the present invention for image content analysis. In the embodiment illustrated in FIG. 10, an actual touch condition of the object with respect to the display screen is determined by executing an object contour detection and determining the existence of any mirror image in the acquired invisible light images. As shown, in a step 941 for the image content analysis, it is determined whether there is an image of any specific object shown in the acquired invisible light images. If not, go the step 93 as shown in FIG. 9; or if yes, go to a step 942, in which a contour of the specific object is obtained.

Then, in a step 943, it is determined whether there is a mirror image included in the image of the specific object. If yes, go to a step 944 to obtain a position of the mirror image and use the position of the mirror image as the position on the display screen being touched by the object; or if not, go to a step 945 to obtain a tip portion of the specific object's contour and use a proper part of the tip portion as the object's position. In the illustrated embodiment, the existence of a mirror image is used to determine whether the object has touched the display screen or not. In addition to the determination based on the object's contour, the object's position can also be determined by brightest areas in the acquired invisible light images or by an area of the object image closest to a specific direction.

While the above illustrated embodiment of the method for image content analysis combines two types of determination mechanisms, namely, determination based on the object image contour detection and determination based on the existence of a mirror image of the object image, it is understood the present invention provides some more different determination mechanisms that have also been mentioned above, including determining the object position according to the brightest areas in the acquired invisible light images, determining the object position according to the detected object contour, and determining whether the object touches the display screen according to any existence of a mirror image in the acquired invisible light images. These determination mechanisms can be executed individually or executed in different combinations thereof according on actual need without being limited to the above description.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An optical touch display device, comprising:
a display screen including a display panel and a light source, the display panel displaying data thereon, and the light source emitting a visible light and an invisible light;
at least one image acquisition module being arranged at a peripheral edge of the display screen for acquiring an invisible light image on or above a surface of the display screen; and
a processing module for calculating a spatial position of an object based on a position of the object in the invisible light image acquired by the at least one image acquisition module.

2. The optical touch display device as claimed in claim 1, wherein a coordinate detection zone is defined on or above a surface of a display zone of the display screen, and wherein the spatial position of the object is a coordinate of the object in the coordinate detection zone.

3. The optical touch display device as claimed in claim 1, wherein the light source includes a red light emitting module, a blue light emitting module, and a green light emitting module; and the red light emitting module has an emission wavelength ranged between 700 nm and 1400 nm.

4. The optical touch display device as claimed in claim 1, wherein the processing module determines a contour of the object according to relatively bright areas in the invisible light image, and then determines the position of the object in the invisible light image according to the contour of the object.

5. The optical touch display device as claimed in claim 1, wherein the invisible light image includes a mirror image of the object in contact with the display screen, and the processing module determines the position of the object in the invisible light image according to the mirror image.

6. The optical touch display device as claimed in claim 1, wherein the at least one image acquisition module is three in number, and the three image acquisition modules are separately arranged at an upper left corner, an upper right corner, and an upper side of the display screen.

7. The optical touch display device as claimed in claim 1, wherein the at least one image acquisition module is one in number, and the image acquisition module is arranged at an upper side of the display screen.

8. An optical touch display method, comprising the following steps:
providing a light source in a display screen, and the light source being able to emit an invisible light;
arranging at least one image acquisition module at a peripheral edge of the display screen;
using the at least one image acquisition module to acquire an invisible light image on or above a surface of the display screen; and
using a processing module to calculate a spatial position of an object based on a position of the object in the invisible light image acquired by the at least one image acquisition module.

9. The optical touch display method as claimed in claim 8, further comprising the step of defining a coordinate detection zone on or above a surface of a display zone of the display screen, and the spatial position of the object is a coordinate of the object in the coordinate detection zone.

10. The optical touch display method as claimed in claim 8, wherein the light source includes a red light emitting module, a blue light emitting module, and a green light emitting module; and the red light emitting module has an emission wavelength ranged between 700 nm and 1400 nm.

11. The optical touch display method as claimed in claim 8, wherein the processing module determines a contour of the object according to relatively bright areas in the invisible light image, and then determines the position of object in the invisible light image according to the contour of the object.

12. The optical touch display method as claimed in claim 8, wherein the invisible light image includes a mirror image of the object in contact with the display screen, and the processing module determines the position of the object in the invisible light image according to the mirror image.

13. The optical touch display method as claimed in claim 8, wherein the at least one image acquisition module is three in number, and the three image acquisition modules are separately arranged at an upper left corner, an upper right corner, and an upper side of the display screen.

14. The optical touch display method as claimed in claim 8, wherein the at least one image acquisition module is one in number, and the image acquisition module is arranged at an upper side of the display screen.
